(19) United States
(12) Patent Application Publication
(10) Pub. No.: US 2003/0023664 A1
(43) Pub. Date: Jan. 30, 2003

(54) Web page cache-on-demand

(76) Inventor: Stefan Mark Elmer, Copenhagen (DK)

Correspondence Address: STEFAN MARK ELMER, STOCKFLETHSVEJ 34, FREDERIKSBERG, 2000, DK

(21) Appl. No.: 09/917,050

(22) Filed: Jul. 30, 2001

(51) Int. Cl. G06F 15/16

(52) U.S. Cl. 709/200

(57) ABSTRACT

Caching is a widely used technology on the Web, particularly by search engines which follow hyperlinks and generate indexes and directories of Web pages and their contents. Indeed, some search engines allow users to view pages as they were last retrieved by the search engine. Whether a given page exits in the cache or not, however, is completely arbitrary, and so is the time of its retrieval. The ‘Web page cache-on-demand’ process allows Web users to decide exactly when a given Web page should be retrieved and cached, thereby significantly improving Web users' ability to document Web contents.

The process of ‘Web page cache-on-demand’ has been implemented by the inventor on the Web site http://www.freezepage.com. It is believed to be the first Web site of its kind; no similar functionality has been identified on other sites.

### CROSS-REFERENCE TO RELATED APPLICATIONS

Not applicable

### STATEMENT REGARDING FEDERALLY SPONSORED R&D

Not applicable

### REFERENCE TO A MICROFICHE APPENDIX

Not applicable

### BACKGROUND OF THE INVENTION

The invention pertains to documentation issues on the World Wide Web (WWW). One problem related to the WWW is the fact that Web pages change continuously, either in terms of content or in terms of addresses (URLs). Even though most current Web browsers (e.g. Microsoft Internet Explorer v. 4.0 and up) allow users to take copies of Web pages by saving them locally (e.g. to their hard disk), users are not able to fully document the content of a given page subsequently, since the HTML code and other elements of the page (such as images) can be easily modified after they have been saved locally. This makes it impossible for users of the WWW to prove the content of specific Web pages without using witness statements, should disagreement occur between the publisher of the Web page (i.e. the Web site owner) and the user.

### BRIEF SUMMARY OF THE INVENTION

Through the process of ‘Web page cache-on-demand’, users can cache Web pages onto an internet-connected system and, at a later point of time, recall the Web pages from the system exactly as they were published on the WWW. Since the process allows its users to save, but not modify, Web contents and since the system must record data such as the address (URL) and time of retrieval for each page, the users can prove the authenticity of cached Web pages as well as their time of existence. The value of the process is thus the fact that, at any time, a Web page can be recalled exactly as it was published on the Internet earlier, through the use of an independent internet-connected system.

### BRIEF DESCRIPTION OF THE SEVERAL VIEWS OF THE DRAWING

Not applicable

### DETAILED DESCRIPTION OF THE INVENTION

The following definitions are used:

‘A Web page’ refers to one or more files that can be downloaded from the World Wide Web and displayed or played back in a Web browser upon the user input of a URL. In most cases, such a Web page will consist of HTML code with a number of embedded elements, such as images, video clips, style sheets, etc. In other cases, however, a Web page consists of one element only, such as an image, a video, an audio clip, etc.

A URL is a unique Web address, e.g. http://www.uspto.gov/web/menu/pats.html, which indicates where a Web page can be found on the Web.

‘The system’ refers to a Web site using the process of Web page cache-on-demand.

‘The user’ refers to a visitor at such a Web site.

The process of Web page cache-on-demand can be described as a number of sequential steps:

1. The user specifies which Web page should be cached, either directly (e.g. by writing the URL on an HTML form) or indirectly (e.g. by pressing a browser button supplied by the system owners which then submits the URL of the user's current Web page to the system).

2. The system acts as a normal Web browser, i.e. it requests the Web page via the Internet using the URL mentioned above, as well as all the embedded elements (pictures, style sheets, video clips, etc.) on the Web page. The system caches the Web page and all its elements, i.e. it saves them locally onto its hard disk or other storage device.

3. Optionally, the system confirms that the page has been retrieved and displays one or more of the following:

The Web page as it was retrieved via the Internet.

The time and date upon which the Web page was retrieved.

A page ID (name or number) that uniquely identifies the Web page on the system.

4. At a later time and date, the user can recall the cached Web page by specifying its unique page ID, either directly (e.g. by writing it on an HTML form) or indirectly (e.g. by clicking on a link on a list of cached pages provided by the system). The system will then display the Web page as it was retrieved via the Internet as well as its original Web address and the time/date on which the retrieval took place.

What I claim as my invention is:

1. The process of allowing a Web user to specify and save Web contents (such as an HTML page) together with its Web address (URL) and the current time/date in an internet-connected system (with a Web interface), so that the Web contents can be recalled later in its exact form together with the retrieval time/date and the original Web address (URL).
